(19) United States
(12) Patent Application Publication
(10) Pub. No.: US 2020/0264788 A1
(43) Pub. Date: Aug. 20, 2020

(54) OPTIMAL CACHE RETENTION MECHANISM

(71) Applicant: QUALCOMM Incorporated, San Diego, CA (US)

(72) Inventors: Raghavendra SRINIVAS, Blacksburg, VA (US); Kaustav ROYCHOWDHURY, Bangalore (IN); Siddesh HALAVARTHI MATH REVANA, Bangalore (IN)

(21) Appl. No.: 16/277,668

(22) Filed: Feb. 15, 2019

(51) Int. Cl. G06F 3/06; G06F 12/084

(52) U.S. Cl. CPC G06F 3/0634; G06F 3/0604; G06F 12/084; G06F 3/0644; G06F 3/0673; G06F 3/0625

(57) ABSTRACT

Systems and methods for memory power management may receive a wake up event in retention mode that may be used to control three memory sequencers that wake up respective groups of memory sequencers.

### FIELD OF DISCLOSURE

Disclosed aspects are directed to power management policies and architectures thereof for memory structures. More specifically, exemplary aspects are directed to managing wake up events for memory structures in low power modes such as retention modes.

### BACKGROUND

Modern processors have ever increasing demands on performance capabilities and low power computing. To meet these demands, different power modes may be employed for different types of components based on their desired performance and latency metrics, for example, when switching between power states.

For instance, some high performance components such as central processing units which may be woken up from a standby or low power state based on an interrupt or qualifying event may have low latency demands, and so their power modes may be controlled using architectural clock gating techniques, which may not result in high power savings. Memory structures such as L1, L2, L3 caches, etc., may be placed in a retention mode by reducing their voltage supply and also collapsing peripheral logic controlling them, which would incur higher latencies to exit the retention mode but may have higher power savings. Furthermore, some components may be completely power collapsed in low power states, thus involving high latencies to exit but also leading to high power savings.

Among these different power modes, the retention mode offers an intermediate low power mode with power saving capacity which lies between the architectural dynamic clock gating and the power collapsed mode. The retention mode offers low wake-up latency and good power savings. As noted above, when a memory structure is placed in the retention mode, the peripheral circuitry may be power collapsed while power supply to a memory bit cell core may be retained (with or without a lower power supply, e.g., through a low-dropout voltage (LDO) regulator). In the retention mode, the voltage supply to the memory bit cell core is reduced to the minimum voltage which would guarantee retention of the information therein.

Memory structures in retention mode may be woken up for several reasons. Waking up a memory structure involves applying power and clock signals to the memory structure so that it may resume normal operations, the opposite of putting the memory structure to sleep. Among these are events like snoop requests (also referred to as snoops) from one or more processing cores, interrupts, etc. In more detail, snoops may be of different types. In multi-core processing systems, when coherency is expected between different memory structures, coherency snoops may be utilized to ensure coherency across the memory structures of the coherency domain.

The coherency snoops may be non-data snoops, e.g., for cache maintenance operations (CMO), wherein the CMO snoops may incur only a change in a tag state of a cache line. The CMO snoops may be initiated by cache coherency hardware or may be pursuant to software based invalidation requests (e.g., invalidation of an instruction cache or “I-cache”, translation lookaside buffer (TLB), etc.). The coherency snoops may also be data snoops which expect data in response. In a shared programming model, instructions or data regions may be shared among multiple processing elements or cores (or generally, multiple masters). The multiple masters may be connected to slaves such as shared memory structures through interconnects. The multiple masters, the interconnect systems, or associated snoop logic may be configured to generate and transmit snoop requests.

In general, a snoop may wake up a core in retention mode, and upon servicing the snoop, the core may re-enter the retention mode. Snoop filters may be employed to limit the masters that a snoop may wake up. Rather than broadcasting all snoops to all masters, the filters may direct the snoops to selected masters (e.g., with mechanisms to ensure that only memories with valid cache lines allocated with pertinent data may be woken up due to a particular snoop). The snoop filtering mechanisms reduce the waking up of cores and also the snoop traffic on the interconnects.

Despite the above mechanisms being in place in conventional implementations of processing systems, cores and memory structures in retention mode are woken up to service both hardware and software snoops directed at them for maintaining coherency and snoops which expect data in response. These wake ups from retention mode incur latency and leakage power, which may offset the power savings in the retention mode. Further, the wake up processes may entail turning on or off power switches which supply power to the periphery logic of the memory structures, and the toggling of power switches leads to their ageing.

Accordingly, there is a need for improved mechanisms for handling of snoops and other wake up events of memory structures in retention mode.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method includes: receiving a wake up event in retention mode for a processing system comprising one or more memory structures including a first, second, and third group of memory structures; controlling at least a first memory sequencer, a second memory sequencer, and a third memory sequencer based on the wake up event; waking up at least the first group of memory structures from retention mode based on the first memory sequencer; waking up at least the second group of memory structures from retention mode based on the second memory sequencer; and waking up at least the third group of memory structures from retention mode based on the third memory sequencer.

In another aspect, an apparatus includes: a processing system with one or more memory structures including a first, second, and third group of memory structures; a power controller of the processing system configured to receive a wake up event and control at least a first memory sequencer, a second memory sequencer, and a third memory sequencer based on the wake up event, wherein: the first memory sequencer is configured to wake up at least the first group of memory structures from retention mode; the second memory sequencer is configured to wake up at least the second group of memory structures from retention mode; and the third memory sequencer is configured to wake up at least the third group of memory structures from retention mode.

In still another aspect, an apparatus includes: a processing system with one or more memory structures including a first, second, and third group of memory structures; means for controlling power of the processing system, the means for controlling power configured to receive a wake up event and control at least a first memory sequencer, a second memory sequencer, and a third memory sequencer based on the wake up event, wherein: the first memory sequencer is configured to wake up at least the first group of memory structures from retention mode; the second memory sequencer is configured to wake up at least the second group of memory structures from retention mode; and the third memory sequencer is configured to wake up at least the third group of memory structures from retention mode.

Other features and advantages associated with the apparatus and methods disclosed herein will be apparent to those skilled in the art based on the accompanying drawings and detailed description.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a method for managing wake up of memory structures based on a wake up event, according to aspects of this disclosure.

FIG. 2 illustrates different power rails which may be used for supplying power to an exemplary processing system, according to aspects of this disclosure.

FIG. 3 illustrates an exemplary apparatus configured for power management based on managing wake up of memory structures of a processing system, according to aspects of this disclosure.

FIG. 4 illustrates another method for power management based on wake up events, according to aspects of this disclosure.

FIG. 5 illustrates an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

Exemplary aspects of this disclosure are directed to power management techniques directed to improved handling of wake up events for memory structures in retention mode. The type of wake up event is determined and based on different types of wake up events, memory structures or portions thereof are selectively woken up. During wake up of a specific memory structure, power is applied to the power rail supplying that particular memory structure as well as a clock signal. As described below, the aspects disclosed herein include selectively waking up memory structures (as opposed to a conventional wake up, such as an interrupt, that wakes up all memory structures of the computing device) based on a snoop type to only wake up memory that is necessary to service the snoop request. As discussed in the background, a snoop request or snoop refers to an “ACSNOOP” signal as described in the well-known ACE protocol for ARM processors, for example. The ACE protocol is a protocol for maintaining cache coherency. As shown in Table 1 below, example wake-up event signals are decoded as shown:

TABLE 1

| Wake-up | Group3 RAMs −> | Improvement in |
|---|---|---|
| Event | Wakeup Required? | Power Savings |
| Interrupt | YES | NA |
| Snoop Hit | NO | YES |

Table 2 below, shows other Snoop types according to the ACE standard.

TABLE 2

| | | Tag State | Group 2/ | |
|---|---|---|---|---|
| | | Dirty/ | DATA | Improve- |
| | | Clean | RAMs | ment in |
| | Data | in Snoop | Wakeup | Power |
| Snoop Txn type | Required? | Filter? | Required? | Savings |
| ReadOnce | YES | NA | YES | NA |
| ReadShared | YES | NA | YES | NA |
| ReadClean | YES | NA | YES | NA |
| ReadNotSharedDirty | YES | NA | YES | NA |
| ReadUnique | YES | NA | YES | NA |
| CleanShared | YES | Dirty | YES | NA |
| CleanInvalid | YES | Dirty | YES | NA |
| CleanShared | YES | CLEAN | NO | YES |
| CleanInvalid | YES | CLEAN | NO | YES |
| MakeInvalid | NO | NA | NO | YES |
| DVM Complete | NO | NA | NO | YES |
| DVM Message | NO | NA | NO | YES |

Cache coherency for shared memories is important and updates to shared memory should be visible to all of the processors sharing it, raising a cache coherency issue. Accordingly, shared data may also have the attribute that it must “write-through” an L1 cache to an L2 cache (if the L2 cache backs the L1 cache of all processors sharing the page) or to main memory. Additionally, to alert other processors that the shared data has changed (and hence their own L1-cached copy, if any, is no longer valid), the writing processor issues a request (e.g., a snoop request) to all sharing processors to invalidate or update the corresponding line in their L1 cache. Inter-processor cache coherency operations are referred to generally as snoop requests or snoops.

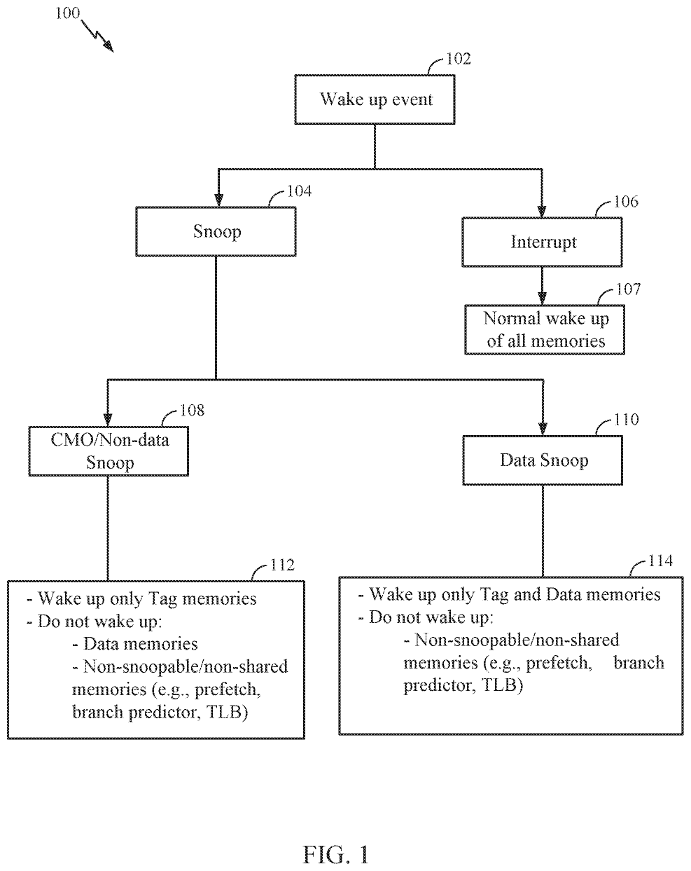

With reference to FIG. 1, an exemplary power management technique is shown in method 100. Method 100 may be employed by a processing system comprising one or more processing cores and one or more caches (e.g., L1, L2, L3, etc.). More specifically, method 100 may be applicable for waking up the one or more memories in a retention mode based on the type of wake up event. Method 100 may be implemented by a power management unit or a cache power controller to improve the wake up latencies and leakage power.

In block 102, a wake up event may be received, which may lead to one of blocks 104 or 106 based on whether the wake up event is a snoop or an interrupt, respectively. For an interrupt, method 100 may proceed to block 107 wherein all memories may be woken up in a conventional manner without applying further optimizations in this regard.

From block 104, exemplary selective wake up techniques may be applied, wherein method 100 proceeds to blocks 108 or 110 based on whether the snoop is a CMO/non-data snoop or a data snoop, respectively, as follows.

From block 108, for the case when the snoop is a CMO/non-data snoop, method 100 proceeds to block 112, wherein only tag portions of cache lines in a memory, for example, are woken up. Data memories and non-snoopable/non-shared memories (e.g., prefetch buffers, branch predictors, TLBs, etc.) are not woken up.

From block 110, for the case when the snoop is a data snoop, method 100 proceeds to block 114, wherein only tag and data portions of cache lines in a memory, for example, are woken up. Non-snoopable/non-shared memories (e.g., prefetch buffers, branch predictors, TLBs, etc.) are not woken up.

For implementing method 100, the memories of the processing system are grouped into three categories, with respective memory sequencers for controlling their wake up events, as noted below. A first memory sequencer controls the wake up for a first group of memories comprising tag arrays of memories. A second memory sequencer controls the wake up for a second group of memories comprising data arrays of memories. A third memory sequencer controls the wake up for a third group of memories comprising non-snoopable/non-shared memories such as prefetch buffers, branch predictors, TLBs, etc. A snoop type decoder and dirty indicator are used as part of snoop logic, which helps a power controller manage the above memory sequencers to achieve leakage savings.

With reference to FIG. 1, the power controller implements method 100 by triggering the respective memory sequencer based on the particular wake up event and snoop type. For instance, if the wake up event is a CMO/non-data only snoop (block 108), only the first memory sequencer is triggered to wake up only the first group or tag memories (block 112). If the wake up event is a data snoop (block 110), the first and second memory sequencers are triggered to wake up only the first and second groups (tag and data memories). If the wake up event is an interrupt (block 106), the first, second, and third memory sequencers are triggered to wake up all memories including the first, second, and third groups.

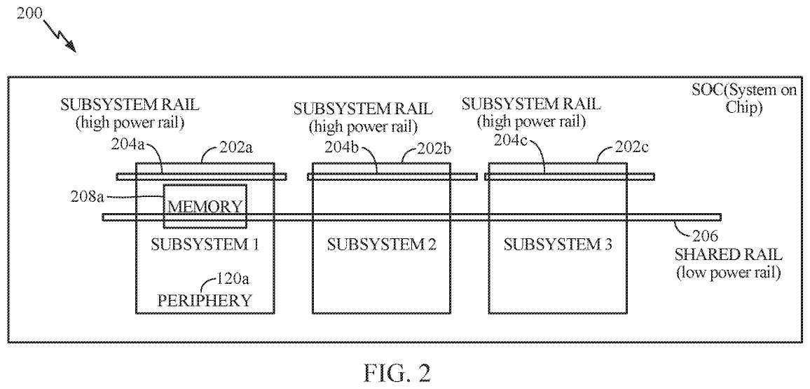

FIG. 2 illustrates aspects of different power rails for delivering power to components/subsystems in integrated circuits of processing system 200 which may be configured according to exemplary aspects. FIG. 2 shows processing system 200 which may be a system on chip (SoC) in an example, with processing system 200 comprising at least the three subsystems identified with reference numerals 202a-c. Each one of the subsystems 202a-c may include a variety of functional logic without loss of generality. The memory instances in subsystems 202a-c, e.g., memory 208a, may be connectable to and configured to be powered by a shared power rail denoted as shared rail 206. Subsystems 202a-c may also have respective dedicated power rails denoted as respective subsystem rails 204a-c to supply power to standard logic cells in the respective subsystems 202a-c.

Accordingly, in an implementation wherein subsystem 202a comprises memory 208a and peripheral logic 210a (e.g., comprising read/write circuitry for memory 208a), at least two power modes may be provided, wherein, in a turbo mode, memory 208a may be coupled to the high power subsystem rail 204a (e.g., 5 volts or 3 volts, for example), while in a nominal or low power mode, memory 208a may be coupled to the low power shared rail 206 (e.g., 2.5 volts or 1.8 volts, for example). In an example, memory 208a may comprise several memory instances. One or more power muxes may be used in switching the connection of the plurality of memory instances of memory 208a from subsystem rail 204a to shared rail 206, or from shared rail 206 to subsystem rail 204a.

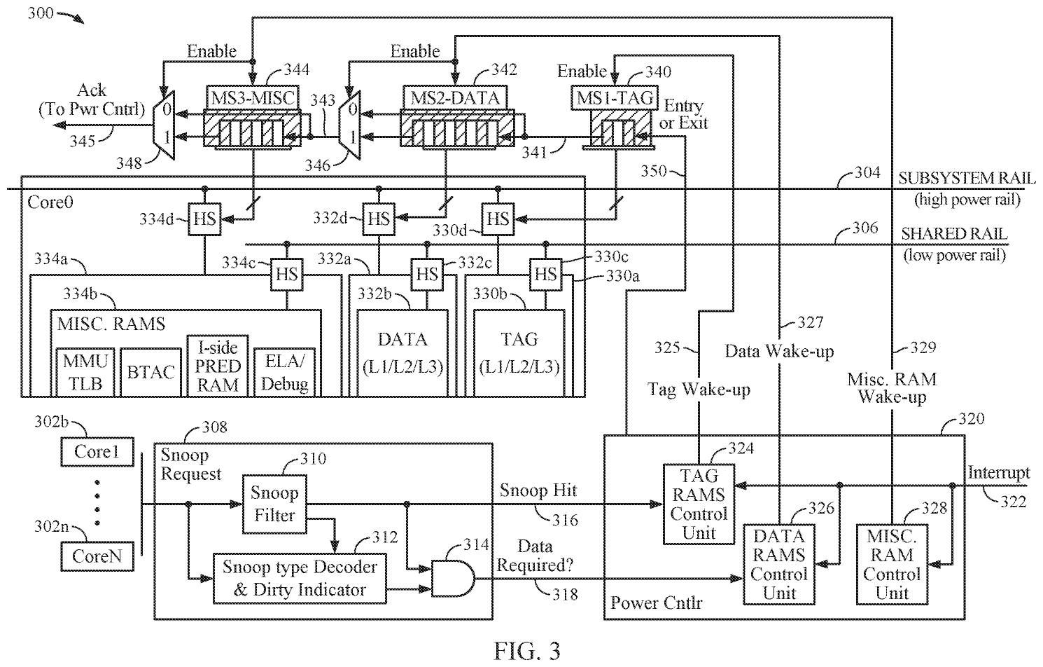

With reference now to FIG. 3, additional details of a subsystem of processing system 300 is shown, with a low power rail such as shared rail 306 and a high power rail such as subsystem rail 304 (similar to the shared and subsystem rails discussed in FIG. 2). Several cores 302a-n have been illustrated in an implementation wherein processing system 300 is a multi-core processing system. Of these, an expanded view of core 302a is shown, with different functional units and memory structures. While one or more caches such as L1, L2, L3, etc., may be present, the illustration shown for core 302a depicts their possible make up without delving into particular interconnections or configurations thereof. As such, each of the memory structures such as L1, L2, L3 caches may have a tag portion to confirm whether a cache line indexed with a memory address is present in the respective cache, and a data portion, which may hold data (making note that the reference to “data” herein includes both data and instructions). The tag portion may be implemented as a tag array which may be logically separate from a data array of the data portion, with a one-to-one correspondence between tags of the tag array and cache lines in the data array.

The tag portion of an example memory is shown as tag 330b (e.g., a first group of memories), with peripheral logic 330a related to tag 330b. The corresponding data portion is shown as data 332b (e.g., a second group of memories) with respective peripheral logic 332a. Other memory structures, referred to as miscellaneous memories are shown as block 334b, which may comprise, for example, a memory management unit (MMU) TLB, a branch target address cache (BTAC), an instruction side prediction memory, an embedded logic analyzer (ELA) or debugger memory, etc. Corresponding peripheral logic 334a is also shown. For the various blocks 330b, 332b, 334b, a connection to shared rail 306 may be through respective or more head switches (HS) 330c, 332c, and 334c; and similarly a connection from peripheral logic blocks 330a, 332a, 334a to subsystem rail 304 may be through one or more head switches (HS) 330d, 332d, and 334d. Controlling the respective head switches for the various blocks can place the blocks in low power modes such as retention modes and enable their wake up, as will be discussed below.

The one or more cores 302a-n may make snoop requests for cache maintenance or coherence, which may be received by snoop controller 308. Snoop controller 308 may include snoop filter 310 as previously discussed, to channel the snoop to a respective one or more cores' memories. The type of the snoop (CMO/non-data/data) and whether a data that would be snooped is dirty may be determined by block 312. Dirty data is data that is unintentionally inaccurate, incomplete or inconsistent as opposed to modified data that was changed intentionally. Dirty indication helps in this way—if Snoop request is to flush the data (because it erroneous), then wake-up of data may be required only if data was dirty/modified with respect to main memory. Logic 314 may combine the information from block 312 and a target core obtained from snoop filter 310, and may determine whether there is a snoop hit (316) and if data is required (318). A snoop hit occurs when the snoop being processed indicates that the data in a cache line is invalide (or needs to be updated). This information, along with any received interrupt 322 is supplied to power controller 320. Based on low level design, the blocks 312/314 or wake-up event (interrupt) to power controller may also need to honor TLB/I-side/BTAC invalidation requests and wake-up necessary non-snoop able memories. These requests may come as a hardware snoop or from software.

Power controller 320 includes separate blocks for controlling wake up of the blocks 330a-b, 332a-b, and 334a-b discussed above. Specifically, entry or exit into retention mode is supplied by signal 350 based on the wake-up events such as inputs snoop hit 316, and interrupt 322. Tag control unit 324 provides tag wake up signal 325 to wake up the first group of memories (tag 330b) for a respective core 302a-n when snoop hit 316 is asserted, and whether or not data required 318 is asserted, e.g., per blocks 112 and 114 of FIG. 1. Data control unit 326 provides data wake up signal 327 when there is snoop hit 316 asserted and data required 318 asserted, to wake up the second group of memories (data 332b), e.g., per block 114 of FIG. 1. Finally, miscellaneous control unit 328 provides miscellaneous wake up signal 329 for block 334b when there is an interrupt 322 asserted, keeping in mind that when interrupt 322 is asserted, tag wake up 325 signal and data wake up signal 327 are also asserted.

First, second, and third memory sequencers 340, 342, and 344, respectively, are implemented as shift registers to allow staggering wake ups of respective groups of memories (using HSs noted above), to handle inrush. Each logical memory in the above groups may be made up of one or more memory instances, with each memory instance having its own HS, thus each HS block illustrated may be composed of multiple component HSs. Staggering the wake up of different memory structures or components thereof may avoid high inrush currents that may be seen when the memory structures are woken up simultaneously, but may increase latency as a trade-off.

If the wake up event is a CMO/non-data only snoop (block 108), only first memory sequencer 340 is triggered to wake up based on tag wake up signal 325, which enables HS 330d for peripheral logic 330a to enable the first group of memories or tag 330b (e.g., per block 112). Memory in retention means periphery logic 330a may be power collapsed and 330b may be still powered-up to retain the contents, (the voltage to retain may be lowered using any other technique power mux, ldo, etc.). So wake-up here means powering up periphery logic (read, write, decoding circuitry) and enabling corresponding clock gating cell (CGC) to provide clock to memories (this feature may be part of periphery logic itself).

If the wake up event is a data snoop (block 110), the first and second memory sequencers 340 and 342, based on tag wake up signal 325 and data wake up signal 327, are triggered to first wake up the first group of memories as above, and then (based on completion signal 341 when the first memory sequencer has completed wake up of the first group of memories) the second group of memories comprising data 332b and peripheral logic 332a by turning on HS 332c

If the wake up event is an interrupt (block 106), the first, second, and third memory sequencers 340, 342, and 344 are triggered to wake up all memories including the first and second groups of memories as described above, and using mux 346 to generate completion signal 343, the third group of memories comprising block 334b and peripheral logic 334a by turning on HS 334c

After any one or more of the three groups have been woken up as described above, mux 348 generates completion signal 345, which then provides an acknowledgement back to power controller 320 to indicate that all of the expected groups of memories have been woken up for a respective wake up event. The muxes 346 and 348 help to bypass sequencers 342 and 344 if in case second and/or third group of memories were not required to be woke-up respectively, so that either 341 or 343 can drive the acknowledgement 345.

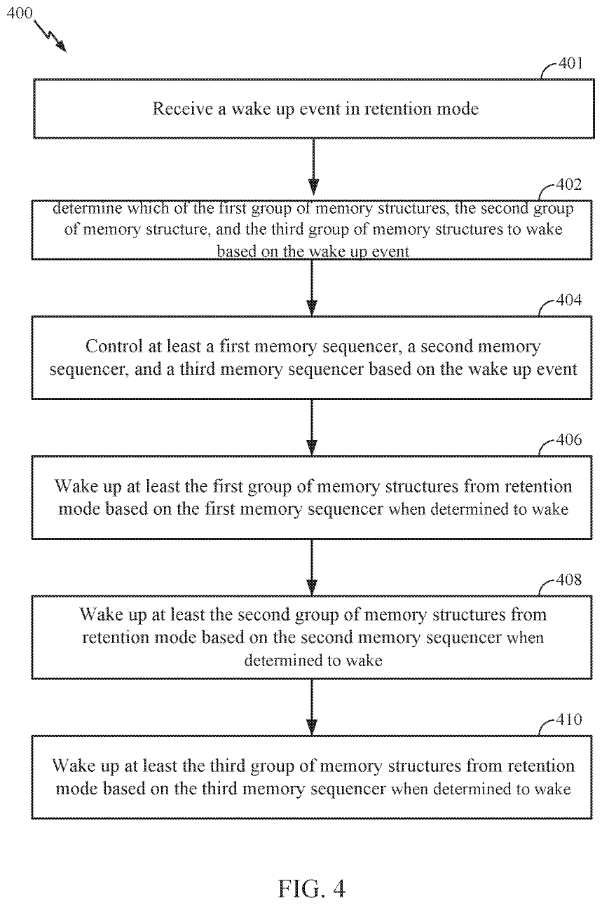

It will be appreciated that exemplary aspects include various methods for performing the processes, functions and/or algorithms disclosed herein. For example, FIG. 4 illustrates a method 400 of memory power management (e.g., in processing system 300).

Block 401 comprises receiving a wake up event in retention mode for the processing system, wherein the processing system comprises one or more memory structures including a first group (e.g., 330a-b), second group (e.g., 332a-b), and third group (e.g., 334a-b) of memory structures.

Block 402 comprises determining which of the first group of memory structures (e.g., 330a-b), the second group of memory structure (e.g., 332a-b), and the third group of memory structures (e.g., 334a-b) to wake based on the wake up event. For example, when the wake up event is a non-data snoop or cache maintenance operation snoop, only the first group of memory structures are to be woken (i.e., taken out of retention mode by applying a power supply and a clock signal). When the wake up event is a data snoop, only the first group of memory structures and the second group of memory structures (alternatively only the second group) are to be woken. Similarly, when the wake up event is an interrupt, the first group of memory structures, the second group of memory structures, and the third group of memory structures are to be woken (i.e., a complete recovery from retention mode back to normal operations). The determination may be made by, for example, comparing a snoop request type to a table to find a match for the type and based on the type (such as interrupt, data snoop, etc., see for example Table 2 above), the processor may then determine which memory groups are necessary to service the snoop request.

Block 404 comprises controlling at least a first memory sequencer (e.g., 340), a second memory sequencer (e.g., 342), and a third memory sequencer (e.g., 344) based on the wake up event (e.g., using wake up signals 325, 327, and 329, respectively).

Block 406 comprises waking up at least the first group of memory structures from retention mode based on the first memory sequencer (e.g., for CMO, non-data snoops and data snoops, as in blocks 112 and 114 of FIG. 1).

Block 408 comprises waking up the second group of memory structures from retention mode based on the second memory sequencer (e.g., data snoops, as in block 114 of FIG. 1); and

Block 410 comprises waking up the third group of memory structures from retention mode based on the third memory sequencer (e.g., based on an interrupt, as in block 107 of FIG. 1).

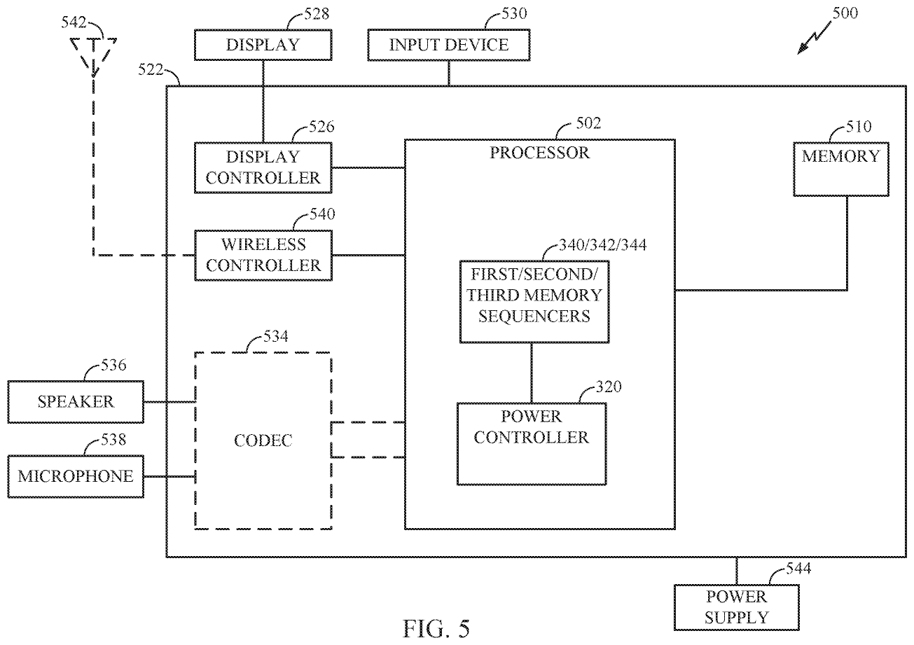

An example apparatus, in which exemplary aspects of this disclosure may be utilized, will now be discussed in relation to FIG. 5. FIG. 5 shows a block diagram of computing device 500. Computing device 500 may correspond to an exemplary implementation of processing system 300 comprising processor 502, e.g., core 302a as shown in FIG. 3. Processor 502 may be in communication memory 510, which may represent the memory groups discussed herein. In processor 502, some of the details shown in previous figures have been omitted for the sake of clarity, but the first, second, and third memory sequencers 340, 342, and 344 and power controller 320 have been notionally illustrated.

FIG. 5 also shows display controller 526 that is coupled to processor 502 and to display 528. In some cases, computing device 500 may be used for wireless communication, and FIG. 5 also shows optional blocks in dashed lines, such as coder/decoder (CODEC) 534 (e.g., an audio and/or voice CODEC) coupled to processor 502 and speaker 536 and microphone 538 can be coupled to CODEC 534; and wireless antenna 542 coupled to wireless controller 540 which is coupled to processor 502. Where one or more of these optional blocks are present, in a particular aspect, processor 502, display controller 526, memory 510, and wireless controller 540 are included in a system-in-package or system-on-chip device 522.

According to a particular aspect, input device 530 and power supply 544 are coupled to system-on-chip device 522. Moreover, in a particular aspect, as illustrated in FIG. 5, where one or more optional blocks are present, display 528, input device 530, speaker 536, microphone 538, wireless antenna 542, and power supply 544 are external to system-on-chip device 522. However, each of display 528, input device 530, speaker 536, microphone 538, wireless antenna 542, and power supply 544 can be coupled to a component of system-on-chip device 522, such as an interface or a controller.

It should be noted that although FIG. 5 generally depicts a computing device 500, processor 502 and memory 510, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

FIG. 6 illustrates another method for power management based on wake up events, according to aspects of this disclosure.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for power management of memory structures based on allocation policies thereof. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of memory power management, the method comprising:
receiving a wake up event in retention mode for a processing system comprising one or more memory structures including a first, second, and third group of memory structures;
determining which of the first group of memory structures, the second group of memory structure, and the third group of memory structures to wake based on the wake up event;
controlling at least a first memory sequencer, a second memory sequencer, and a third memory sequencer based on the wake up event;
waking up at least the first group of memory structures from retention mode based on the first memory sequencer when determined to wake;
waking up at least the second group of memory structures from retention mode based on the second memory sequencer when determined to wake; and
waking up at least the third group of memory structures from retention mode based on the third memory sequencer when determined to wake.

2. The method of claim 1, wherein the wake up event is one of a non-data snoop or cache maintenance operation snoop, a data snoop, or an interrupt.

3. The method of claim 2, wherein the first group of memory structures comprises tag arrays, the second group of memory structures comprises data arrays, and the third group of memory structures comprises non-snoopable or non-shared memory structures.

4. The method of claim 3, comprising waking up only the first group of memory structures if the wake up event is for the non-data snoop or cache maintenance operation snoop.

5. The method of claim 3, comprising waking up only the first group of memory structures and the second group of memory structures if the wake up event is the data snoop.

6. The method of claim 3, comprising waking up the first group of memory structures, the second group of memory structures, and the third group of memory structures if the wake up event is the interrupt.

7. The method of claim 1, wherein for the one or more memory structures in retention mode, placing a memory bit cell core in a reduced voltage state and power collapsing peripheral logic thereof.

8. An apparatus comprising:
a processing system with one or more memory structures including a first, second, and third group of memory structures;
a power controller of the processing system configured to receive a wake up event and control at least a first memory sequencer, a second memory sequencer, and a third memory sequencer based on the wake up event, wherein:
the first memory sequencer is configured to wake up at least the first group of memory structures from retention mode;
the second memory sequencer is configured to wake up at least the second group of memory structures from retention mode; and
the third memory sequencer is configured to wake up at least the third group of memory structures from retention mode.

9. The apparatus of claim 8, wherein the wake up event is one of a non-data snoop or cache maintenance operation snoop, a data snoop, or an interrupt.

10. The apparatus of claim 9, wherein the first group of memory structures comprises tag arrays, the second group of memory structures comprises data arrays, and the third group of memory structures comprises non-snoopable or non-shared memory structures.

11. The apparatus of claim 10, wherein the first memory sequencer is configured to wake up only the first group of memory structures if the wake up event is for the non-data snoop or cache maintenance operation snoop.

12. The apparatus of claim 10, wherein the first memory sequencer and the second memory sequencer are respectively configured to wake up the first group of memory structures and the second group of memory structures if the wake up event is the data snoop.

13. The apparatus of claim 10, wherein the first memory sequencer, the second memory sequencer, and the third memory sequencer are respectively configured to wake up the first group of memory structures, the second group of memory structures, and the third group of memory structures if the wake up event is the interrupt.

14. The apparatus of claim 10 comprising one or more head switches and power muxes configured to place a memory bit cell core in a reduced voltage state and power collapse peripheral logic thereof in the retention mode of a memory structure comprising the memory bit cell core and the peripheral logic.

15. The apparatus of claim 10, wherein the first, second, and third memory sequencers respectively comprise shift registers configured to stagger wake up of respective first, second, and third groups of memory structures.

16. An apparatus comprising:
a processing system with one or more memory structures including a first, second, and third group of memory structures;
means for controlling power of the processing system, the means for controlling power configured to receive a wake up event and control at least a first memory sequencer, a second memory sequencer, and a third memory sequencer based on the wake up event, wherein:
the first memory sequencer is configured to wake up at least the first group of memory structures from retention mode;
the second memory sequencer is configured to wake up at least the second group of memory structures from retention mode; and
the third memory sequencer is configured to wake up at least the third group of memory structures from retention mode.

17. The apparatus of claim 16, wherein the wake up event is one of a non-data snoop or cache maintenance operation snoop, a data snoop, or an interrupt.

18. The apparatus of claim 17, wherein the first group of memory structures comprises tag arrays, the second group of memory structures comprises data arrays, and the third group of memory structures comprises non-snoopable or non-shared memory structures.

19. The apparatus of claim 18, wherein the first memory sequencer is configured to wake up only the first group of memory structures if the wake up event is for the non-data snoop or cache maintenance operation snoop.

20. The apparatus of claim 19, wherein the first memory sequencer and the second memory sequencer are respectively configured to wake up the first group of memory structures and the second group of memory structures if the wake up event is the data snoop.
